(19) United States
(12) Patent Application Publication
(10) Pub. No.: US 2009/0134722 A1
(43) Pub. Date: May 28, 2009

(54) MAGNET ENGINE

(76) Inventor: Henry Robert Gasull, III, Elliottsburg, PA (US)

Correspondence Address: H. ROBERT GASULL III, 481 FOOSE RIDGE ROAD, ELLIOTTSBURG, PA, 17024, US

(21) Appl. No.: 11/672,517

(22) Filed: Nov. 23, 2007

(51) Int. Cl. H02K 33/00

(52) U.S. Cl. 310/20; 310/48; 310/46

(57) ABSTRACT

The invention disclosed is a magnet engine, more specifically an engine that derives its power from the power contained in a magnet (22) and employs a cam or barrel drive mechanism (28) to translate the power in the magnet (22) into useful power output. The magnet engine is comprised generally of one or more in-line reciprocating magnet (22) and piston (20) component pairs arranged circularly around and parallel to a central axis, one or more variable magnetic field conductors (23) positioned generally between and generally equidistant from each of the magnet (22) and piston (20) components, in a magnet (22) and piston (20) component pair, that effect a reciprocating motion in the magnet (22) and piston (20) components, and one or more cam drives (28), positioned concentric to the magnet (22) and piston (20) component pairs, that are employed to translate the reciprocating motion of the magnet (22) and piston (20) component pairs into rotary motion. Both reciprocating motion and rotary motion can be obtained as useful power output.

### CROSS-REFERENCE TO RELATED APPLICATIONS

The present application claims the benefit of U.S. Provisional Patent Application No. 60/771,401, filed Feb. 8, 2006 by the present inventor.

### FEDERALLY SPONSERED RESEARCH

Not Applicable

### OVERVIEW

The invention disclosed is a magnet engine, more specifically an engine that derives its power from the power contained in a magnet 22 and employs a cam or barrel drive mechanism 28 to translate the power in the magnet 22 into useful power output. The magnet engine is comprised generally of one or more in-line reciprocating magnet 22 and piston 20 component pairs arranged circularly around and parallel to a central axis, one or more variable magnetic field conductors 23 positioned generally between and generally equidistant from each of the magnet 22 and piston 20 components, in a magnet 22 and piston 20 component pair, that effect a reciprocating motion in the magnet 22 and piston 20 components, and one or more cam drives 28, positioned concentric to the magnet 22 and piston 20 component pairs, that are employed to translate the reciprocating motion of the magnet 22 and piston 20 component pairs into rotary motion. Both reciprocating motion and rotary motion can be obtained as useful power output.

### BRIEF DESCRIPTION OF THE DRAWINGS

FIG. 1 is a perspective view of a magnet engine 10, according to an embodiment of the present invention. This embodiment has a single magnet 22/22′ and piston 20/20′ component pair, two cam drives 28/28′ each having a single sinusoidal cycle, and a single movable variable magnetic field conductor 23 with a single more magnetically conducting portion 26 and a single less magnetically conducting portion 24.

FIG. 2 is a perspective view of a magnet engine 12, according to an embodiment of the present invention. This embodiment has four magnet 22/22′ and piston 20/20′ component pairs, two cam drives 28/28′ each having a single sinusoidal cycle, and a single movable variable magnetic field conductor 23 with a single more magnetically conducting portion 26 and a single less magnetically conducting portion 24.

FIG. 3 is a perspective view of a magnet engine 14, according to an embodiment of the present invention. This embodiment has a single magnet 22/22′ and piston 20/20′ component pair, two cam drives 28/28′ each having two sinusoidal cycles, and a single movable variable magnetic field conductor 23 with two more magnetically conducting portions 26/26′ and two less magnetically conducting portions 24/24′.

FIG. 4 is a perspective view of a magnet engine 16, according to an embodiment of the present invention. This embodiment has eighteen magnet 22.1/22.2/22.3 and piston 20.1/20.2/20.3 components, six of which have a magnet 22.2L/22.2R at each end, resulting in twelve magnet 22 and piston 20 component pairs, three cam drives 28.1/28.2/28.3 each having two sinusoidal cycles, and two movable variable magnetic field conductors 23.1/23.2 each with two more magnetically conducting portions 26 and two less magnetically conducting portions 24.

FIG. 5 is a perspective view of a magnet engine 18, according to an embodiment of the present invention, this embodiment has four magnet and piston component pairs 20/22 20′/22′, two cam drives 28/28′ each having two sinusoidal cycles positioned external to the magnet and piston component pairs 20/22 20′/22′, and a single movable variable magnetic field conductor 23 with two more magnetically conducting portions 26/26′ and two less magnetically conducting portions 24/24′.

FIG. 6 is a perspective view of a magnet engine 19, according to an embodiment of the present invention, this embodiment has three magnet and piston component pairs 20/22 20′/22′, two cam drives 28/28′ each having two sinusoidal cycles, and three fixed position variable magnetic field conductors 23 with a means to control 44 the state of the magnetically conducting properties of the variable magnetic field conductor 23.

FIG. 7 is a graphic representation of the forces and motion of the magnet and piston component pairs 20/22 20′/22′ on the cam drives 28/28′ in relation to the state of the variable magnetic field conductor 23 at various points in the cycle of the magnet engine.

FIG. 8 is a further graphic representation of the forces and motion of the magnet and piston component pairs 20/22 20′/22′ on the cam drives 28/28′ in relation to the state of the variable magnetic field conductor 23 at various points in the cycle of the magnet engine.

FIG. 9 is an example of an embodiment of the variable magnetic field conductor 23 with various regions representing portions of the variable magnetic field conductor 23 that are more magnetically conducting 26 and portions that are less magnetically conducting 24.

FIG. 10 is another example of an embodiment of the variable magnetic field conductor 23 with various regions representing portions of the variable magnetic field conductor 23 that are more magnetically conducting 26 and portions that are less magnetically conducting 24. In addition this example of the variable magnetic field conduction has regions that are more electrically conducting 99.

FIG. 10′ is exploded view of the embodiment of the variable magnetic field conductor 23 depicted in FIG. 10 with various regions representing portions of the variable magnetic field conductor 23 that are more magnetically conducting 26 and portions that are less magnetically conducting 24. In addition this example of the variable magnetic field conduction has regions that are more electrically conducting 99.

### LIST AND DESCRIPTION OF COMPONENTS COMPRISING THE MAGNET ENGINE

10—2 Magnet 22 and piston 20 component, 2 Cam drive 28, 1 Variable magnetic conductor 23, Single Cycle Magnet Engine

12—8 Magnet 22 and piston 20 component, 2 Cam drive 28, 1 Variable magnetic conductor 23, Single Cycle Magnet Engine

14—2 Magnet 22 and piston 20 component, 2 Cam drive 28, 1 Variable magnetic conductor 23, Double Cycle Magnet Engine

16—18 Magnet 22 and piston 20 component, 3 Cam drive 28, 2 Variable magnetic conductor 23, Double Cycle Magnet Engine

18—8 Magnet 22 and piston 20 component, 2 Cam drive 28, 1 Variable magnetic conductor 23, Double Cycle Magnet Engine

19—6 Magnet 22 and piston 20 component, 2 Cam drive 28, 3 Variable magnetic conductor 23, Double Cycle Magnet Engine

20—Piston 20 part of the magnet 22 and piston 20 component. The entire piston 20 can be a magnet 22. The piston 20 can be any shape or size such that it is able to transmit the power to the cam drive 28. The piston 20 can hold the means to reduce friction 36 between itself and the cam drive 28, or be designed in such a way as to reduce the friction. The piston 20 is also designed such that it will incorporate a means maintain its proper alignment 38 with the cam drive 28 through interaction with the frame 30, cam drive 28 or other means. Any suitable means can be used to maintain alignment 38 and/or reduce friction 36 and is within the scope of the present invention as will be appreciated by those skilled in the art. The piston 20 component could have magnetic shielding incorporated into it such the magnetic field surrounding the piston 20 and the magnet 22 would be held more closely to the magnet 22 and piston 20 component in order to allow closer positioning of magnet 22 and piston 20 components in a magnet engine.

22—Magnet 22 portion of the magnet 22 and piston 20 component. The magnet 22 can be of any size or shape, and comprise any portion of the piston 20 component, including the entire piston 20, according to the design and requirements of the embodiment of a magnet engine. The magnets 22 can be arranged with one or both (as in a U shaped magnet) like poles facing one another so that there is a natural repulsive force between the magnets 22 in the magnet 22 and piston 20 component pairs. If the magnets are arranged with like poles facing one another, then a magnet engine according to the present invention will operate under any one of several scenarios. In the first scenario there is a repulsive force between the magnets 22 when the less magnetically conducting portion 24 of the variable magnetic field conductor 23 is disposed between them, and there is an attractive force between the magnets 22 and the more magnetically conducting portion 26 of the variable magnetic field conductor 23 when this portion is disposed between the magnets 22. The resultant attractive and repulsive forces are both used to power a magnet engine. In the second scenario there is an attractive force between the magnets 22 and all portions, or the majority, of the variable magnetic field conductor 23, but there is a greater attractive force between the more magnetically conducting portion 26 of the variable magnetic field conductor 23 such that this force will overcome the attractive force between the magnets 22 and the less magnetically conducting portion 24 of the variable magnetic field conductor 23 and be sufficient to power a magnet engine. In the third scenario there is a repulsive force between the magnets 22 and all portions, or the majority, of the variable magnetic field conductor 23, but there is a greater repulsive force between magnets 22 when the less magnetically conducting portion 24 of the variable magnetic field conductor 23 is disposed between them such that this force will overcome the repulsive force between the magnets 22 and the more magnetically conducting portion 26 of the variable magnetic field conductor 23 and be sufficient to power a magnet engine. In the fourth scenario the less magnetically conducting portion 24 of the variable magnetic field conductor 23 would serve to neutralize the repulsive force between the magnets 22, allowing the more magnetically conducting portion 26 of the variable magnetic field conductor 23 to have a net attractive force between itself and the magnets 22 and be sufficient to power a magnet engine. In the fifth scenario the more magnetically conducting portion 26 of the variable magnetic field conductor 23 would serve to neutralize the repulsive force between the magnets 22, allowing the less magnetically conducting portion 24 of the variable magnetic field conductor 23 to have a net repulsive force between itself and the magnets 22 and be sufficient to power a magnet engine.

Alternately, if the magnets 22 are arranged such that unlike poles face one another, so that there is a naturally attractive force between the magnets 22, then the magnet engine will have a variable magnetic field conductor 23 that will serve to first allow or enhance the attraction between the magnets 22 causing them to move towards one another. And then the variable magnetic field conductor 23 will change state such that it will cause the magnets 22 to move away from one another. An example of such a variable magnetic field conductor 23 would be an electromagnet that would alternately change the direction of its magnetic orientation. First being the same direction as the magnets 22 in the magnet 22 and piston 20 component pairs, and would cause the magnets 22 to move towards one another. And then the electromagnet would reverse its magnetic orientation and cause the magnets 22 to move away from one another.

It is also possible that electromagnets are used as the magnet 22 in the magnet 22 and piston 20 component, and the magnet engine would include the circuitry to provide the electric current for the electromagnet. Any necessary control circuitry would be provided as well. If electromagnets were used it is possible that the control circuitry would switch the direction of the current flow in the electromagnet, and thus reverse the direction of magnetization in the electromagnet, and induce the reciprocating motion in the magnet 22 and piston 20 component. In this case the variable magnetic field conductor 23 may or may not be included in the magnet engine.

The following components are not shown in the drawings but are optional components of a magnet engine, related to the magnet 22 components, and within the spirit and scope of the present invention. The magnet 22 and piston 20 component could also have a pole piece incorporated into it, in order to focus the magnetic field, and also serve to protect the magnet 22. It is also possible that electrically conducting material be place in a stationary position, attached to the frame 30 by some means, in close proximity to the magnets 22, such that when the magnets 22 move in a reciprocating motion usable electrical current is induced in the electrically conducting materials. Additionally, electrically conducting material could encase the magnets 22 such that at predetermined points in the reciprocating motion of a magnet 22 an electrical current could be induced in the electrically conducting material causing a magnetic field to be created that could assist in the reciprocating motion of the magnet 22 and piston 20 component and the operation of a magnet engine. All necessary control circuitry would also be a component of such a magnet engine. This control circuitry could also make use of the back electromotive force (EMF) of the collapsing magnetic field in the electrically conducting material that encased the reciprocating magnet 22 and piston 20 components.

23—Variable magnetic field conductor 23. A variable magnetic field conductor 23 can be either generally fixed in position or movable such that it is able to perform the function of varying the magnetic field that exists between the magnet 22 and piston 20 components pairs. If the variable magnetic field conductor 23 is movable, the driving force may come from the cam drive 28 and shaft 32 or from another source, in which case there would not be a mechanical connection between the cam drive 28 and the movable type of variable magnetic field conductor 23. If the variable magnetic field conductor 23 is generally fixed in position, then it could be made of an electromagnet and work as described earlier, or be made of another material, for example a domain switching ferroelectric ceramic. A movable variable magnetic field conductor 23 could have a flywheel component 34 incorporated into it. A movable variable magnetic field conductor 23 could also have various means employed to maintain a stable position in a magnet engine. Any suitable means can be used and is within the scope of the present invention as will be appreciated by those skilled in the art.

24—Less magnetically conducting portion 24 of the movable variable magnetic field conductor 23 or less magnetically conducting period of a fixed variable magnetic field conductor 23 cycle. Example materials with little or no properties of magnetic conductivity, but by no means a complete list, are air, wood, plastic, aluminum, certain grades of stainless steel, etc. An example material with greater magnetic conductivity than the preceding listed materials, but by no means a complete list, is soft iron. Example materials with an even greater magnetic conductivity than the preceding listed materials, but by no means a complete list, are soft magnetic nanocrystalline alloys, Supermalloy (NiFeMo), Permalloy (NiFe), and MuMetal (NiFeCuCr), materials that are used for magnetic shielding. The magnetic conductivity or permeability of certain metals such as those used for magnetic shielding can be enhanced by processes such as annealing. So the less magnetically conducting portion 24 could be a magnetic shielding material that has not been annealed or has a lesser degree of annealing, and a more magnetically conducting portion 26 would be a magnetic shielding material that has been more fully annealed. This portion of the variable magnetic field conductor 23 could also be laminated with alternating sections of less magnetically conducting material 24 and non-electrically conducting material, for example but not limited to a plastic material or epoxy, to reduce the eddy currents that would be created by moving an electrically conducting material through a magnetic field. It could also not be laminated, as previously described, in order to increase the repulsive force between the magnets 22, because the eddy currents created in the less magnetically conducting material 24, if the material were electrically conducting, would be in magnetic opposition to the magnetic field in which the electrically conducting material is moving through.

It is also possible that materials with other magnetic properties, for example diamagnetic (for example Bismuth), ferrimagnetic (for example Magnetite), and paramagnetic (for example Aluminum), materials be incorporated into the variable magnetic field conductor 23. As an example, but not meant to be limiting the spirit and scope of the invention, the more magnetically conducting portion 26 of the variable magnetic field conductor 23 could be made of a paramagnetic material while the less magnetically conducting portion 24 could be made of a diamagnetic material.

26—More magnetically conducting portion 26 of the movable variable magnetic field conductor 23 or more magnetically conducting period of a fixed variable magnetic field conductor 23 cycle. As stated previously, example materials with little or no properties of magnetic conductivity, but by no means a complete list, are air, wood, plastic, aluminum, certain grades of stainless steel, etc. An example material with greater magnetic conductivity than the preceding listed materials, but by no means a complete list, is soft iron. Example materials with an even greater magnetic conductivity than the preceding listed materials, but by no means a complete list, are soft magnetic nanocrystalline alloys, Supermalloy (NiFeMo), Permalloy (NiFe), and MuMetal (NiFeCuCr), materials that are used for magnetic shielding. The magnetic conductivity or permeability of certain metals such as those used for magnetic shielding can be enhanced by processes such as annealing. So the less magnetically conducting portion 24 could be a magnetic shielding material that has not been annealed or has a lesser degree of annealing, and a more magnetically conducting portion 26 would be a magnetic shielding material that has been more fully annealed. This portion of the variable magnetic field conductor 23 could be laminated with alternating sections of magnetically conducting material and non-electrically conducting material, for example but not limited to a plastic material or epoxy, to reduce the eddy currents that would be created by moving an electrically conducting material through a magnetic field. The laminations of material could be in any direction within the variable magnetic field conductor 23. Powdered metal processes could also be used to construct a variable magnetic field conductor 23 with various materials with various magnetic conducting properties in different portions of the component. Any suitable means can be used and is within the scope of the present invention as will be appreciated by those skilled in the art.

It is also possible that materials with other magnetic properties, for example diamagnetic (for example Bismuth), ferrimagnetic (for example Magnetite), and paramagnetic (for example Aluminum), materials be incorporated into the variable magnetic field conductor 23. As an example, but not meant to be limiting the spirit and scope of the invention, the more magnetically conducting portion 26 of the variable magnetic field conductor 23 could be made of a paramagnetic material while the less magnetically conducting portion 24 could be made of a diamagnetic material.

28—Cam drive 28 (also known as a barrel drive). The cam drive 28 can have cam that is either protruding outward, or grooved or indented inward, and can be either internally or externally positioned in relation to the magnet 22 and piston 20 components. The cam on the cam drive 28 can be comprised of any generally sinusoidal cam as required by the design of the embodiment of the magnet engine and its desired use and output properties, i.e. it does not have to be a strict sine curve as depicted in the drawings. The cam drive 28 serves the purpose of translating the reciprocating motion of the magnet 22 and piston 20 components into rotational motion, and to maintain the position of each of the magnet 22 and piston 20 components in each magnet 22 and piston 20 component pair generally equidistant from the variable magnetic field conductor 23. The cam drive 28 can also have a flywheel 34 component incorporated into it. Though all the embodiments of a magnet engine depicted herein show the cam drive 28 as a rotational component, it is possible to construct a magnet engine wherein the cam drive 28 does not rotate. In such an embodiment the magnet 22 and piston 20 components would rotate as well as reciprocate. In such an embodiment a fixed variable magnetic field conductor 23 would rotate with the magnet 22 and piston 20 components. In this scenario a movable variable magnetic field conductor 23 would remain fixed in position in relation to the cam drive 28 while the magnet 22 and piston 20 components would rotate as well as reciprocate.

30—Frame and casing 30 for support, protection, and to maintain the position of the components of a magnet engine. This component could also incorporate various means to reduce friction between components. This component could also have incorporated into it a means to stabilize the movement or rotation of a variable magnetic field conductor 23 or maintain the position of generally fixed position variable magnetic field conductor 23.

32—Shaft 32 maintains the position of the cam drives 28 in relation to one another, and also to the movable variable magnetic field conductor 23 if it is attached. There could also be means on the shaft (not shown) to adjust the position of the movable variable magnetic field conductor 23 in relation to the cam drives 28 to adjust the timing of the cycle for speed and power, and also to stop and start a magnet engine. The shaft 32 can also be used to transmit the output power of a magnet engine as rotational motion. Other means could serve a similar purpose as the shaft 32 that is depicted in the drawing, as will be readily apparent to those skilled in the art.

34—Flywheel 34—This component is optional, but serves the purpose of sustaining, maintaining and smoothing the motion of a magnet engine. The flywheel 34 can be positioned as a stand alone component or incorporated into other components of a magnet engine.

36—Means to reduce friction 36 between the magnet 22 and piston 20 component and the cam drive 28. This can be a bearing, magnetic bearing, low friction material, lubricant, etc.

38—Means to maintain the alignment 38 between the magnet 22 and piston 20 component and the cam drive 28. This can be achieved by the shape of the magnet 22 and piston 20 component, guide slots, guide bearings, by other means, or any combination of the forgoing. The means to maintain alignment 38 could be incorporated into the frame 30.

40—Means to maintain alignment and transmit motion 40 between the cam drive 28 and the variable magnetic field conductor 23 when the cam drive 28 is external to the magnet 22 and piston 20 components and the cam drive 28 is connected to a movable variable magnetic field conductor 23. This component can comprise any portion of a cylinder, or other means. This component can also be used to transmit the output power. It is possible that this component would only connect the cam drives 28, and an alternate means be used to move or change the state of a variable magnetic field conductor 23.

42—Means to guide and position 42 the cam drive 28 and variable magnetic field conductor 23 components when the cam drive 28 is external to the magnet 22 and piston 20 components and the cam drive 28 is connected to a movable variable magnetic field conductor 23. This component can comprise any portion of a cylinder. A separate guiding and positioning means can be provided for the cam drives 28 and the movable variable magnetic field conductor 23 if they are not connected.

44—Means to control 44 the magnetically conducting properties and state of a generally fixed position variable magnetic field conductor 23.

99—Electrically conducting portion 99 of the variable magnetic field conductor 23 that serves to diminish the attraction between the magnet 22 and piston 20 component pairs and the more magnetically conducting portion 26 of the variable magnetic field conductor 23 by creating eddy currents in the electrically conducting portion 99.

M—The direction of rotation or movement M of the referenced component in the embodiment of a magnet engine disclosed in the drawing.

### SPECIFICATION

In accordance with the teachings of the present invention, a magnet engine is disclosed that utilizes the energy contained in a magnet to produce useful power output. The magnet engine utilizes the magnetically attractive and repulsive forces of magnets 22 along with a means to vary the magnet field that exist between the magnets 22, hereinafter being referred to as a variable magnetic field conductor 23, in order to effect a reciprocating motion in a magnet 22 and piston 20 component that acts upon and translates its linear reciprocating motion to rotational motion in a cam drive 28 component.

The magnet engine includes one or more of in-line reciprocating magnet 22 and piston 20 component pairs arranged circularly around and parallel to a central axis, one or more variable magnetic field conductors 23 positioned generally between and generally equidistant from each of the individual magnet 22 and piston 20 components in a magnet 22 and piston 20 component pair that effect a reciprocating motion in the magnet 22 and piston 20 components, and one or more cam drives 28, positioned concentric to the magnet 22 and piston 20 component pairs, that are employed to translate the reciprocating motion of the magnet 22 and piston 20 component pairs into rotary motion. Both reciprocating motion and rotary motion can be obtained as useful power output.

The following discussion of the embodiments of the invention directed to a magnet engine is merely exemplary in nature, and is in no way intended to limit the invention or its application or uses. Additional advantages and features of the present invention will become apparent from the following description and claims, taken in conjunction with the accompanying drawings.

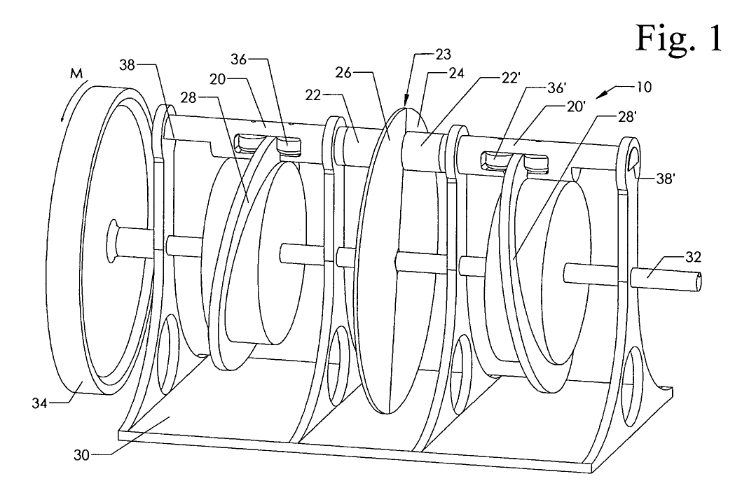

FIG. 1 is a perspective view of a magnet engine 10, according to an embodiment of the present invention. This embodiment has a single magnet 22/22′ and piston 20/20′ component pair that is arranged in a generally in-line configuration parallel to a central rotational axis of the cam drives 28/28′. The magnets 22/22′ in the magnet 22/22′ and piston 20/20′ components are positioned so like poles face one another, i.e. the north pole on magnet 22 faces the north pole on magnet 22′, and/or the south pole on magnet 22 faces the south pole on magnet 22′.

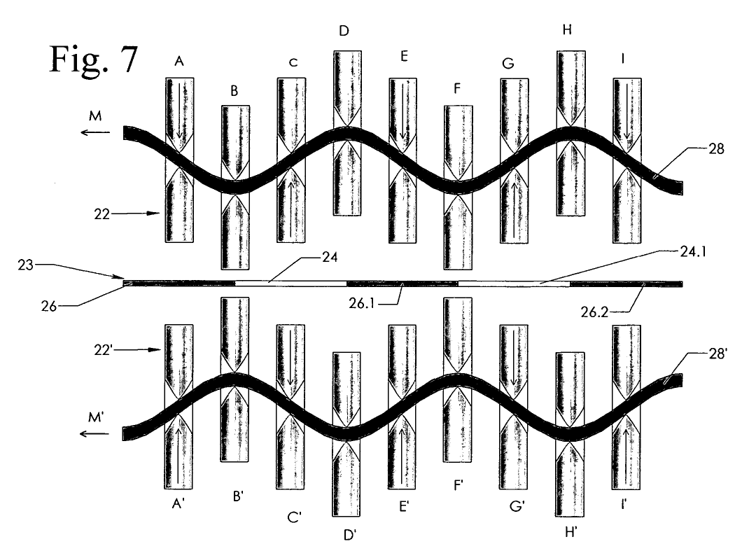

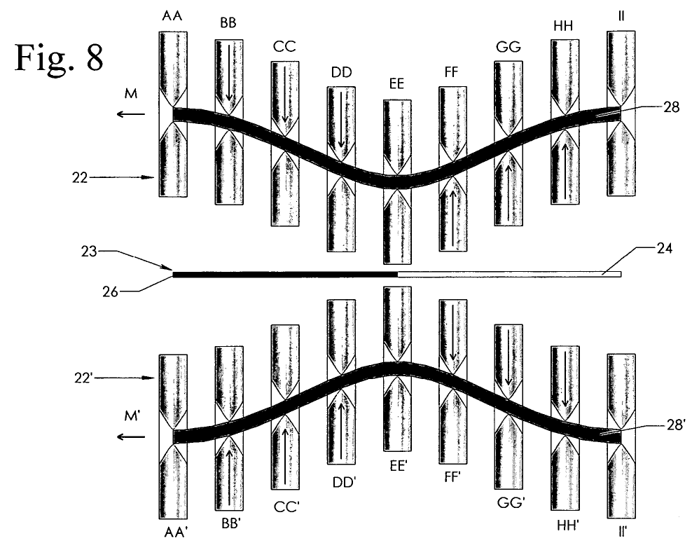

Concentric with the rotational axis and the magnet 22/22′ and piston 20/20′ component pair are two cam drives 28/28′ each having a single sinusoidal cycle. The cam drives 28/28′ are positioned on a central shaft 32, however other means to position the cam drives 28/28′ could be used. Given that there is a single sinusoidal cycle on each cam drive 28/28′ in this embodiment, cam drive 28 is 180° out of phase with cam drive 28′. For any embodiment with more that one cam drive, the degrees out of phase for consecutive cam drives 28/28′ follows the formula—Degrees out of phase=360°/(2×N)—where ‘N’ is the number of sinusoidal cycles on the cam drive 28. It is possible for a magnet engine to have a means to adjust (not shown) the degrees out of phase for consecutive cam drives in order to control the rotation, and as a possible means to stop or start a magnet engine. Any suitable means can be used and is within the scope of the present invention as will be appreciated by those skilled in the art. The cam drives 28/28′ are out of phase with one another so that the reciprocating motion of the magnet 22/22′ and piston 20/20′ components forces the cam drives 28/28′ to rotate. This is explained more fully in FIG. 7 and FIG. 8.

Positioned generally between and generally equidistant from the magnet 22/22′ and piston 20/20′ components is a single movable variable magnetic field conductor 23 with a single more magnetically conducting portion 26 and a single less magnetically conducting portion 24. In this embodiment of the magnet engine 10 the variable magnetic field conductor 23 is connected to the central shaft 32 that is also connected to the cam drives 28/28′. A means (not shown) may be provided to adjust the position of the variable magnetic field conductor 23 in relation to the cam drives 28/28′ to control the rotation of the magnet engine 10 and as a means to stop and start the magnet engine 10 or any other embodiment of a magnet engine. Any suitable means can be used and is within the scope of the present invention as will be appreciated by those skilled in the art.

When the less magnetically conducting portion 24 of the variable magnetic field conductor 23 is positioned between the magnet 22/22′ and piston 20/20′ components the magnet 22/22′ and piston 20/20′ components will magnetically repel and move away from one another forcing the cam drives 28/28′ to rotate, which will cause the central shaft 32 to rotate, which will then cause the variable magnetic field conductor 23 to rotate in direction M. As the variable magnetic field conductor 23 rotates the more magnetically conducting portion 26 of the variable magnetic field conductor 23 will move into position between the magnet 22/22′ and piston 20/20′ components. When the more magnetically conducting portion 26 of the variable magnetic field conductor 23 is positioned between the magnet 22/22′ and piston 20/20′ components the magnet 22/22′ and piston 20/20′ components will be attracted to the more magnetically conducting portion 26 of the variable magnetic field conductor 23 and move towards one another forcing the cam drives 28/28′ to rotate in direction M, which will cause the central shaft 32 to rotate, which will then cause the variable magnetic field conductor 23 to rotate completing the cycle of rotation at which point the cycle will repeat with the less magnetically conducting portion 24 of the variable magnetic field conductor 23 moving into position between the magnet 22/22′ and piston 20/20′ components.

This embodiment of the magnet engine 10 also depicts an optional flywheel component 34 as a means to sustain and smooth the rotation of the magnet engine 10. A means to maintain the position 38/38′ of the magnet 22/22′ and piston 20/20′ components in relation to the cam drives 28/28′ is shown. Also, shown is a frame, encasement, or supporting component 30 for maintaining the position of the other components. Additionally, a means to reduce friction 36/36′ between the magnet 22/22′ and piston 20/20′ components and the cam drives 28/28′ is shown.

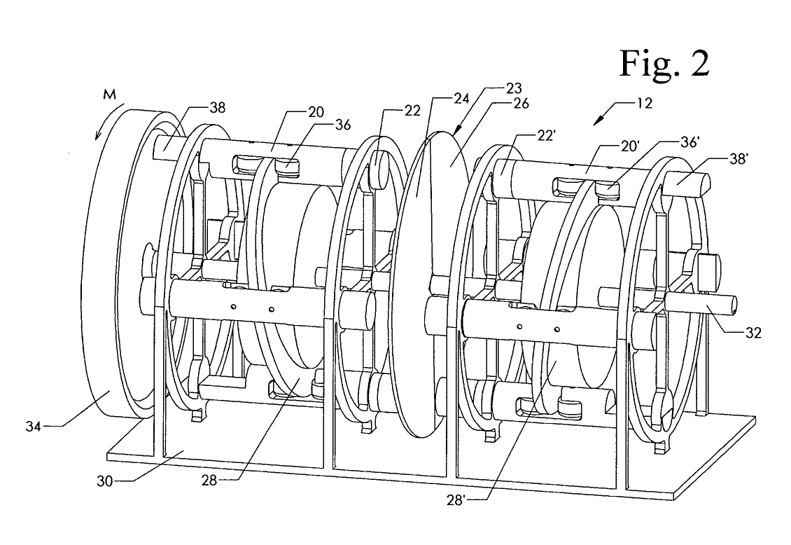

FIG. 2 is a perspective view of a magnet engine 12, according to an embodiment of the present invention. For reasons of brevity and efficiency the main focus of the discussion of this figure will be on unique aspects of this embodiment with additional points added when deemed fitting. The purpose of showing this embodiment is to demonstrate one manner in which a magnet engine can be enhanced to increase the power output by the addition of magnet 22/22′ and piston 20/20′ component pairs. This embodiment has four magnet 22/22′ and piston 20/20′ component pairs positioned concentric to the cam drives 28/28′, two cam drives 28/28′ each having a single sinusoidal cycle, and a single movable variable magnetic field conductor 23 with a single more magnetically conducting portion 26 and a single less magnetically conducting portion 24.

Each magnet 22/22′ and piston 20/20′ component pair in the magnet engine 12 reciprocates in the same manner as described for magnet engine 10 in FIG. 1 through the interaction of the magnetic fields of the magnets 22/22′ with the variable magnetic field conductor 23, and the interaction of reciprocating the magnet 22/22′ and piston 20/20′ components with the cam drives 28/28′. The increase in power for this embodiment of the magnet engine 12 comes from the increased number of magnet 22/22′ and piston 20/20′ component pairs that serve to add motive force to the magnet engine 12 at an increased number of points in its cycle. A more complete description of the forces between the magnet 22/22′ and piston 20/20′ component pairs, the cam drives 28/28′ and the variable magnetic field conductor 23 will be provided with the descriptions of FIG. 7 and FIG. 8.

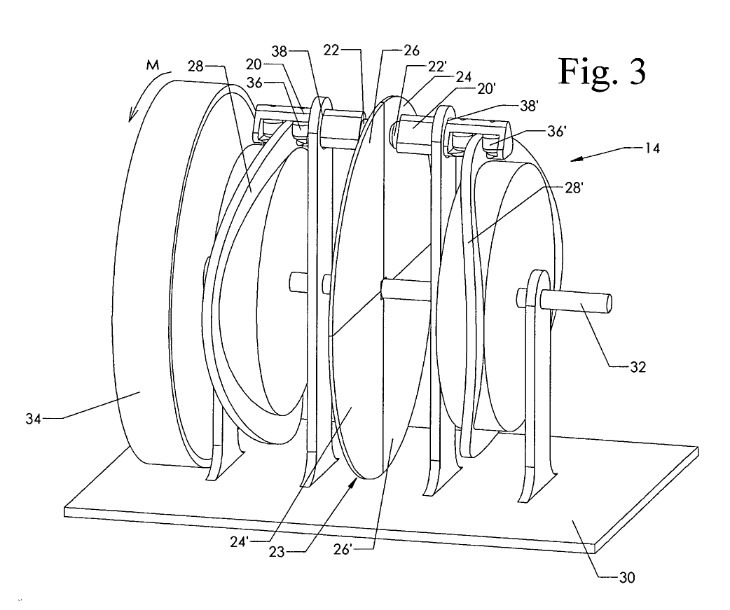

FIG. 3 is a perspective view of a magnet engine 14, according to an embodiment of the present invention. For reasons of brevity and efficiency the main focus of the discussion of this figure will be on unique aspects of this embodiment with additional points added when deemed fitting. The purpose of showing this embodiment is to demonstrate a manner in which a magnet engine can be enhanced by having more than one sinusoidal cycle on a cam drive 28/28′ and the associated enhancements to the variable magnetic field conductor 23. This embodiment has a single magnet 22/22′ and piston 20/20′ component pair, two cam drives 28/28′ each having two sinusoidal cycles, and a single movable variable magnetic field conductor 23 with two more magnetically conducting portions 26/26′ and two less magnetically conducting portions 24/24′.

As with other embodiments of the magnet engine with one or more moveable variable magnetic field conductors 23, the less magnetically conducting portions 24/24′ of the variable magnetic field conductor 23 are associated with the magnetic repulsion and/or movement away from one another of each of the magnet 22/22′ and piston 20/20′ components in a magnet 22/22′ and piston 20/20′ component pair. And further, the more magnetically conducting portions 26/26′ of the variable magnetic field conductor 23 are associated with the magnetic attraction and/or movement towards one another and towards the variable magnetic field conductor 23.

With the magnet engine 14 shown in FIG. 3, for each revolution of the cam drives 28/28′ and variable magnetic field conductor 23 there are four alternating periods for each individual set of magnet 22/22′ and piston 20/20′ component pairs. There are two periods where the each of the magnet 22/22′ and piston 20/20′ components in a magnet 22/22′ and piston 20/20′ component pair are magnetically repelling and/or moving away from one another, and between each of the aforementioned periods there are one of two periods where the each of the magnet 22/22′ and piston 20/20′ components in a magnet 22/22′ and piston 20/20′ component pair are magnetically attracting and/or moving towards one another and towards the variable magnetic field conductor 23. Using the previously stated formula concerning the phase of each of the consecutive cam drives 28/28′, given that there are two sinusoidal cycles on each of the cam drives 28/28′ shown in magnet engine 14 in FIG. 3, then:

Degrees out of phase=360°/(2×2)=90°.

To further clarify the point, the transition from the more magnetically conducting portions 26/26′ to the less magnetically conducting portions 24/24′ of the variable magnetic field conductor 23 are generally in line with the portion of the sinusoidal cycle on the cam drives 28/28′ that is the minimum distance from the variable magnetic field conductor 23. And the transition from the less magnetically conducting portions 24/24′ to the more magnetically conducting portions 26/26′ of the variable magnetic field conductor 23 are generally in line with the portion of the sinusoidal cycle on the cam drives 28/28′ that is the maximum distance from the variable magnetic field conductor 23.

To extend the concept of the sinusoidal cycles on the cam drives 28/28′, if there were three sinusoidal cycles on the cam drives 28/28′ then the cam drives 28/28′ would be 60° out of phase.

Degrees out of phase=360°/(2×3)=60°

If there were four sinusoidal cycles on the cam drives 28/28′ then the cam drives would be 45° out of phase.

Degrees out of phase=360°/(2×4)=45°, and so on.

As stated before, the magnet engine could include a means to vary the degrees out of phase between consecutive cam drives 28/28′ in order to control the rotation of the magnet engine, and also as a possible means to stop and start the magnet engine. Additionally, a means to vary the phase of the cam drives 28/28′ in relationship to the phase of the variable magnetic field conductor 23, meaning the points of transition from a more magnetically conducting portion 26 to a less magnetically conducting portion 24 and vice versa, could be used to control the rotation of a magnet engine, and also as a possible means to stop and start a magnet engine.

The embodiment of the magnet engine 14 shown in FIG. 3 also shows an alternate means to maintain the position 38/38′ of the magnet 22/22′ and piston 20/20′ components in relation to the cam drives 28/28′ by the use of a variation of the shape of the magnet 22/22′ and piston 20/20′ components and the interaction of this shape with the frame 30 or means of supporting the magnet 22/22′ and piston 20/20′ components. Other means to maintain the position 38/38′ of the magnet 22/22′ and piston 20/20′ components in relation to the cam drives 28/28′ can be used as will be familiar to those skilled in the art.

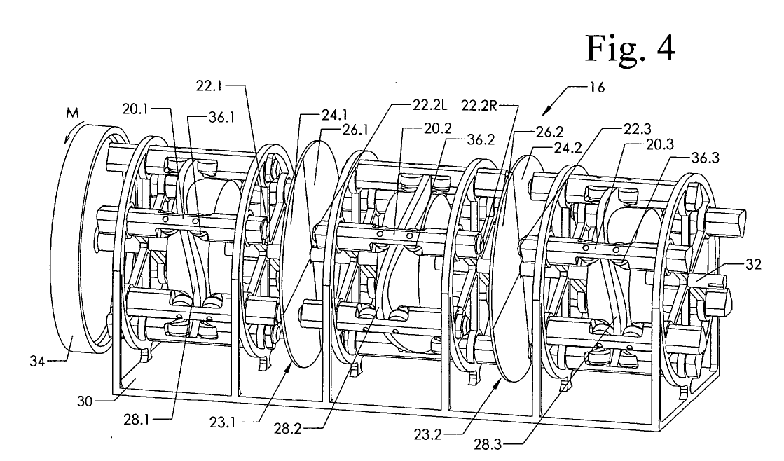

FIG. 4 is a perspective view of a magnet engine 16, according to an embodiment of the present invention. For reasons of brevity and efficiency the main focus of the discussion of this figure will be on unique aspects of this embodiment with additional points added when deemed fitting. The purpose of showing this embodiment is to demonstrate how the power of a magnet engine can be increased by extending the number of cam drives 28, variable magnetic field conductors 23, and magnet 22 and piston 20 component pairs. This embodiment of the magnet engine 16 has eighteen magnet 22 and piston 20 components, six of which are double ended 22.2L/22.2R/20.2, resulting in twelve magnet 22 and piston 20 component pairs, three cam drives 28.1/28.2/28.3 each having two sinusoidal cycles, and two movable variable magnetic field conductors 23.1/23.2 each with two more magnetically conducting portions 26 and two less magnetically conducting portions 24.

A unique aspect of this embodiment of a magnet engine 16 is that a magnet 22.2L/22.2R and piston 20.2 component can have a magnet 22.2L/22.2R component located at each end of the piston 20.2 component and be positioned centrally or between two variable magnetic field conductors 23.1/23.2, that are position a predetermined number degrees out of phase with one another as determined by the calculation of the number of degrees out of phase for the consecutive cam drives 28. While there is a magnetic repelling and/or moving away of one set of magnet 22 and piston 20 components, magnet 22.2L and piston 20.2 component magnetically repelling and/or moving away from magnet 22.1 and piston 20.1 component, there is a magnetic attraction and/or moving towards one another of the magnet 22 and piston 20 components positioned at the other end of the centrally located magnet 22 and piston 20 component, magnet 22.2R and piston 20.2 component magnetically attracting and/or moving towards magnet 22.3 and piston 20.3 component.

Alternately, the entire centrally located magnet 22 and piston 20 component could be one magnet 22.2 in which case the north pole at one end of the magnet would interact with the north pole on the magnet 22 and piston 20 component most closely facing it across a first variable magnetic field conductor 23, and the south pole of the magnet 22.2 would interact with the south pole on the magnet 22 and piston 20 component most closely facing it across a second variable magnetic field conductor 23.

As can be seen in FIG. 4, this embodiment of a magnet engine 16 has cam drives 28.1/28.2/28.3 that have two sinusoidal cycles on each. Given the previously disclosed formula for the degrees out of phase of consecutive cam drives, the degrees out of phase for cam drives 28 for this embodiment of the magnet engine 16 is 90°. The result is that the first cam drive 28.1 is 90° out of phase with the second consecutive cam drive 28.2, and the second consecutive cam drive 28.2 is 90° out of phase with the third cam drive 28.3, but because there are 2 sinusoidal cycles on each cam drive 28, the first cam drive 28.1 is essentially in phase with the third cam drive 28.3. This concept can be extended with additional cam drives 28, and along with the placement of additional magnet 22 and piston 20 component pairs concentric to the cam drives 28 the power output of an embodiment of a magnet engine can be increased.

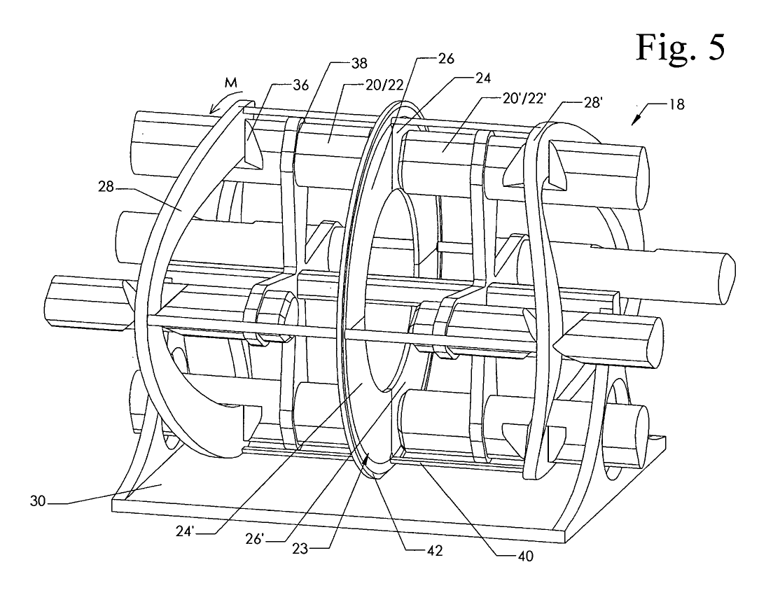

FIG. 5 is a perspective view of a magnet engine 18, according to an embodiment of the present invention. For reasons of brevity and efficiency the main focus of the discussion of this figure will be on unique aspects of this embodiment with additional points added when deemed fitting. This embodiment demonstrates the fact that it is not necessary for the concentric cam drive 28 to be positioned within the magnet 22 and piston 20 components. In this embodiment the cam drives 28/28′ are positioned external to the magnet and piston components 20/22 20′/22′.

It should also be reiterated, as would be familiar to those skilled in the art, that though the cam drives 28 disclosed and depicted in this figure and the other figures show the cam drive 28 as a protrusion into the magnet 22 and piston 20 components, in fact the cam drive 28 may also be indented inwardly or have a groove that is employed to transmit the reciprocating motion of the magnet 22 and piston 20 components to the cam drive 28 via a protrusion, bearing or other means provided on the magnet 22 and piston 20 components.

This embodiment of a magnet engine 18 has four magnet and piston component 20/22 20′/22′ pairs, two cam drives 28/28′, each having two sinusoidal cycles, positioned external to the magnet and piston component 20/22 20′/22′ pairs, and a single movable variable magnetic field conductor 23 with two more magnetically conducting portions 26/26′ and two less magnetically conducting portions 24/24′.

In this embodiment of a magnet engine 18 the magnet and piston components 20/22 are composed entirely of magnetic material. There is also a means to maintain the alignment and transmit motion 40 between any subset of, or all of the following components: cam drive 28, variable magnetic field conductor 23, cam drive 28′. Additionally, there is a means to guide and position 42 the cam drives 28/28′ and variable magnetic field conductor 23 as they rotate. Also this embodiment of a magnet engine 18 depicts an alternative shape for the magnet and piston component 20/22, and demonstrates how this shape and its interaction with the frame 30, components of the magnet engine 18, or other possible means as will be familiar to those skilled in the art, will serve as means to maintain the alignment 38 between the magnet and piston component 20/22 and the cam drive 28.

It is possible that alternative embodiments of a magnet engine would have the cam drive 28 stationary and the magnet 22 and piston 20 components rotate. It is also possible that alternative embodiments of the magnet engine would have a separate source of power for the movement of the variable magnetic field conductor 23. That is to say that there would not be a direct linkage between the cam drive 28 and the variable magnetic field conductor 23 that would cause the rotation or other movement in the variable magnetic field conductor 23.

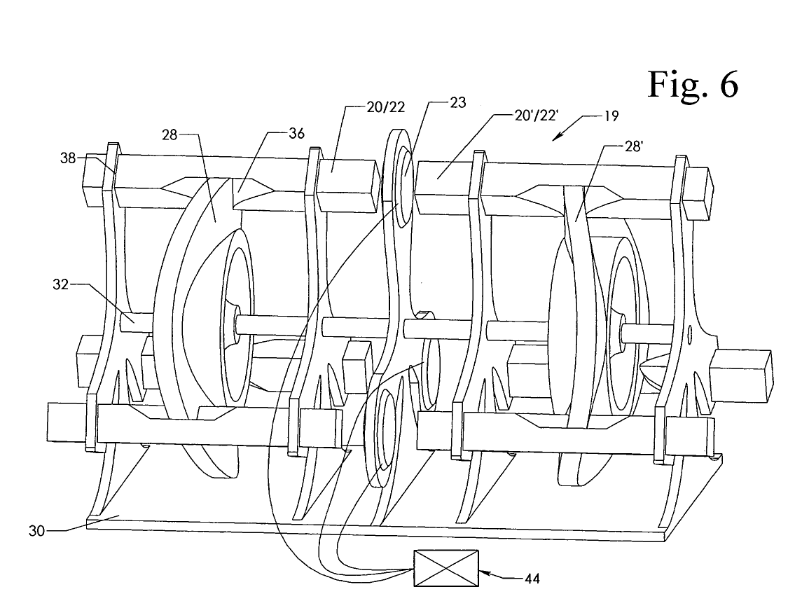

FIG. 6 is a perspective view of a magnet engine 19, according to an embodiment of the present invention. For reasons of brevity and efficiency the main focus of the discussion of this figure will be on unique aspects of this embodiment with additional points added when deemed fitting. This embodiment demonstrates the use of a plurality of variable magnetic field conductors 23 that maintain a generally fixed position in relation to a specific magnet and piston component 20/22 20′/22′ pair. This embodiment has three magnet and piston component 20/22 20′/22′ pairs, two cam drives 28/28′ each having two sinusoidal cycles, and fixed position variable magnetic field conductors 23 with a means to control 44 the magnetically conducting properties and state of the variable magnetic field conductors 23.

The operation of an embodiment of the magnet engine 19 with variable magnetic field conductors 23 that maintains a generally fixed position in relation to a specific magnet and piston component 20/22 20′/22′ pair could be achieved in various ways. It would be possible for the variable magnetic field conductor 23 to be a type of electromagnet that switches its direction of magnetic polarity. This type of variable magnetic field conductor 23 would work with magnet and piston component 20/22 20′/22′ pairs that would be magnetically aligned in the same direction, which is to say that the north pole of one magnet 22 and piston 20 component would face the south pole of the other magnet 22′ and piston 20′ component in a specific magnet and piston component 20/22 20′/22′ pair. When the variable magnetic field conductor 23 was magnetically aligned with the magnet and piston component 20/22 20′/22′ pair the magnet and piston components 20/22 20′/22′ would be magnetically attracted to each other and the variable magnetic field conductor 23, and move towards one another. When the variable magnetic field conductor 23 was in magnetic opposition to the magnet and piston component 20/22 20′/22′ pair the magnet and piston components 20/22 20′/22′ would be magnetically repelled from the variable magnetic field conductor 23 and move away from the variable magnetic field conductor 23. This magnetic attraction and repelling would result in a reciprocating motion in the magnet and piston components 20/22 20′/22′ which then would be transferred to the cam drives 28/28′. Useful power output could be obtained from both the reciprocating motion of the magnet and piston components 20/22 20′/22′ and the rotation of the cam drives 28/28′.

The embodiment of a magnet engine 19 depicted in FIG. 6 could also have variable magnetic field conductor 23 components that were composed of, singly or in combination, other magnetically active materials, or materials able to have their magnetic properties changed by various means such that they would cause a magnet 22 and piston 20 component to effect a reciprocating motion and this reciprocating motion could be translated to rotational motion in a cam drive 28. An example of such material, but not to be construed as limiting, is a domain switching ferroelectric ceramic. As stated before, other materials or combinations of materials, along with a means to control the state of the material's magnetic properties, if necessary, could be used as a variable magnetic field conductor 23 in an alternative embodiment of a magnet engine.

FIG. 7 is a graphic representation of the forces and motion of the magnet 22/22′ components on the cam drives 28/28′ in relation to the state of the variable magnetic field conductor 23 in the cycle of the magnet engine. This figure assumes that each set of magnet 22/22′ component pairs is positioned such that like poles face one another in a naturally magnetically repulsive state. For example the north pole of magnet 22 component A faces the north pole of magnet 22′ component A′, or vice versa with south pole facing south pole. This figure represents two and one half cycles on the sinusoidal cam drives 28/28′ in an embodiment of a magnet engine. It is given that the magnet 22/22′ components are restricted to a reciprocating motion either towards or away from the variable magnetic field conductor 23, and that the cam drives 28/28′ are restricted to a motion that is at a right angle to the motion of the magnet 22/22′ components and parallel to the variable magnetic field conductor 23. It can also be clearly seen that cam drive 28 has a sinusoidal shape that is exactly opposite and mirrors the sinusoidal shape of cam drive 28′ so that an equal force is transmitted to the cam drives 28/28′ by the reciprocating motion of the magnet 22/22′ component pairs. This relationship between the cam drives 28/28′ also serves to maintain the position of each of the magnets 22/22′ in a magnet 22/22′ component pair generally equidistant from the variable magnetic field conductor 23. It will be reiterated here that it is not required that the cam drive 28 have an exact sine curve design, just that the cam drive 28 be of a generally sinusoidal design as meets the requirements of the particular embodiment of a magnet engine.

In this figure it can be seen that magnet 22/22′ components A and A′ have between them a more magnetically conducting portion 26 of the variable magnetic field conductor 23. This causes them to be magnetically attracted to the variable magnetic field conductor 23 and to move towards it and towards one another. As magnet 22/22′ components A and A′ move towards one another they apply a force to the cam drives 28/28′ in the direction shown on magnet 22/22′ components A and A′ and the resulting force on the cam drives 28/28′ is in direction M/M′. Other magnet 22/22′ component pairs that are similarly positioned with more magnetically conducting portions 26.1 26.2 of the variable magnetic field conductor 23 between them and will apply a similar force and in the same direction M/M′ to the cam drives 28/28′ are: E and E′, I and I′.

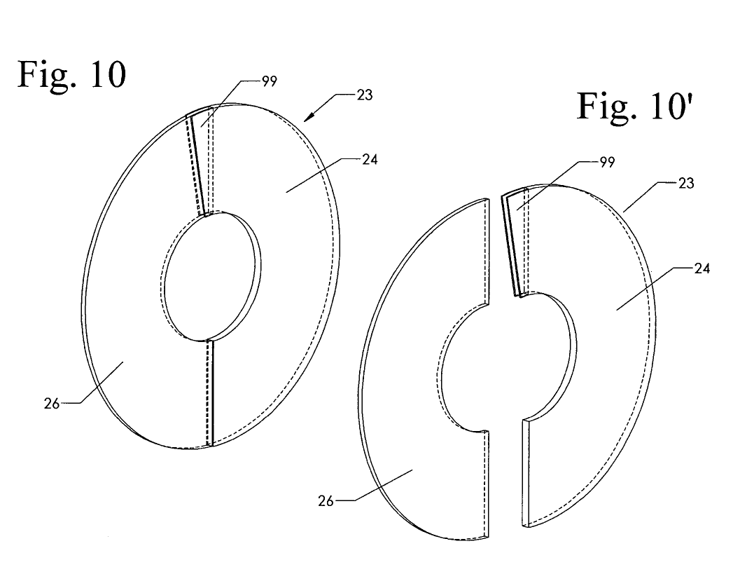

Further, it can be seen that magnet 22/22′ component pair B and B′ have positioned between them a point of transition in the variable magnetic field conductor 23 from a more magnetically conducting portion 26 to a less magnetically conducting portion 24. At this point in the cycle of a magnet engine there could be a resistance to the movement or rotational motion of the variable magnetic field conductor 23 and the magnet engine if the material that the less magnetically conducting portion 24 of the variable magnetic field conductor 23 is made of is non-magnetic material such as, but not limited to, plastic, wood, air, aluminum, etc. This is not a problem if sufficient force in direction M/M′ can be provided otherwise by the other components in the magnet engine. In order to reduce the resistance to movement or rotation of the variable magnetic field conductor 23 and the magnet engine other materials, or combinations of materials, with some magnetic properties such as soft iron, soft magnetic nanocrystalline alloys, Supermalloy (NiFeMo), Permalloy (NiFe), or MuMetal (NiFeCuCr), magnetic shielding materials that are not or are less annealed, or have less magnetically conducting properties than the material that is used in the more magnetically conducting portions 26 of the variable magnetic field conductor 23, could be used in the less magnetically conducting portion 24 of the variable magnetic field conductor 23. There could also be a gradual transition of materials in the variable magnetic field conductor 23 from more magnetically conducting to less magnetically conducting. Lamination and composites of materials could be used as well. For example an electrically conducting material 99 as depicted in FIG. 10 and FIG. 10′ could overlay, or be integrated into by surface or internal lamination, the more magnetically conducting portions 26 of the variable magnetic field conductor 23 at the point of transition from more magnetically conducting portion 26 to less magnetically conducting portion 24. The resulting electrical eddy currents caused by movement of the electrically conducting portion 99 and the counter magnetic field, as will be familiar to those skilled in the art, would ease the transition from more magnetically conducting portion 26 to less magnetically conducting portion 24 in much the same way that magnetic levitation is used to lift a train. At this point in the cycle of a magnet engines the magnet 22/22′ component pair B and B′ are at their closest point together on the sinusoidal cycle of the cam drives 28/28′ and no driving force in direction M/M′ is transmitted to the cam drives 28/28′. Other magnet 22/22′ component pairs at the same point (26.1 transitions to 24.1) in the cycle of the magnet engine are: F and F′.

To continue, magnet 22/22′ component pair C and C′ have between them a less magnetically conducting portion 24 of the variable magnetic field conductor 23. This causes them to be magnetically repelled from each other through the variable magnetic field conductor 23 and to move away from it and away from each other. As magnet 22/22′ component pair C and C′ move away from one another they apply a force to the cam drives 28/28′ in the direction shown on magnet 22/22′ components C and C′ and the resulting force on the cam drives 28/28′ is in direction M/M′. Other magnet 22/22′ component pairs that are similarly positioned with less magnetically conducting portions 24.1 of the variable magnetic field conductor 23 between them and will apply a similar force and in the same direction M/M′ to the cam drives 28/28′ are: G and G′.

It can be seen that magnet 22/22′ component pair D and D′ have positioned between them a point of transition in the variable magnetic field conductor 23 from a less magnetically conducting portion 24 to a more magnetically conducting portion 26.1. At this point in the cycle of the magnet engines the magnet 22/22′ component pair D and D′ are at their farthest point apart on the sinusoidal cycle of the cam drives 28/28′ and no driving force in direction M/M′ is transmitted to the cam drives 28/28′. There could be some attractive force that would act upon the variable magnetic field conductor 23 in direction M/M′ due to the magnetic attraction between the magnet 22/22′ components D and D′ and the more magnetically conducting portion 26 of the variable magnetic field conductor 23. Other magnet 22/22′ component pairs at the same point (24.1 transitions to 26.2) in the cycle of the magnet engine are: H and H′.

It can be seen from the preceding discussion that there are multiple forces in a magnet engine that contribute to the motion of the cam drives 28/28′ in direction M/M′. FIG. 8 will expand upon this concept.

FIG. 8 is a further graphic representation of the forces and motion of the magnet 22/22′ component pairs on the cam drives 28/28′ in relation to the state of the variable magnetic field conductor 23 in the cycle of the magnet engine. For exemplary purposes this figure assumes that each set of magnet 22/22′ component pairs is positioned such that like poles face one another in a naturally magnetically repulsive state. For example the north pole of magnet 22 component AA faces the north pole of magnet 22′ component AA′, or vice versa with south pole facing south pole. This figure represents one cycle on the sinusoidal cam drives 28/28′ in an embodiment of a magnet engine. The purpose of this figure is to show how a magnet engine can be enhanced and the power increased by have multiple magnet 22/22′ component pairs applying force to the cam drives 28/28′ within each sinusoidal cycle. It is given that the magnet 22/22′ components are restricted to a reciprocating motion either towards or away from the variable magnetic field conductor 23. And that the cam drives 28/28′ are restricted to a motion that is at a right angle to the motion of the magnet 22/22′ components and parallel to the variable magnetic field conductor 23.

In this figure it can be seen that multiple magnet 22/22′ component pairs (BB and BB′, CC and CC′, DD and DD′) have between them a more magnetically conducting portion 26 of the variable magnetic field conductor 23. This causes them to be magnetically attracted to the variable magnetic field conductor 23 and to move towards it and towards each other. As the magnet 22/22′ component pairs move towards one another they apply a force to the cam drives 28/28′ in the direction shown on the magnet 22/22′ components, and the resulting force on the cam drives 28/28′ is in direction M/M′.

Additionally, it can be seen that multiple magnet 22/22′ component pairs (FF and FF′, GG and GG′, HH and HH′) have between them a less magnetically conducting portion 24 of the variable magnetic field conductor 23. This causes them to be magnetically repelled from each other through the variable magnetic field conductor 23, and to move away from it and away from each other. As the magnets 22/22′ component pairs move away from one another they apply a force to the cam drives 28/28′ in the direction shown on the magnets 22/22′ components, and the resulting force on the cam drives 28/28′ is in the same direction M/M′.

Further, it can be seen that the magnet 22/22′ component pair AA and AA′ are in a position in the sinusoidal cycle of the cam drives 28/28′ that is similar to that described in FIG. 7 for the magnet 22/22′ component pair D and D′. It can also be seen that the magnet 22/22′ component pair EE and EE′ are in a position in the sinusoidal cycle that is similar to that described in FIG. 7 for the magnet 22/22′ component pair B and B′.

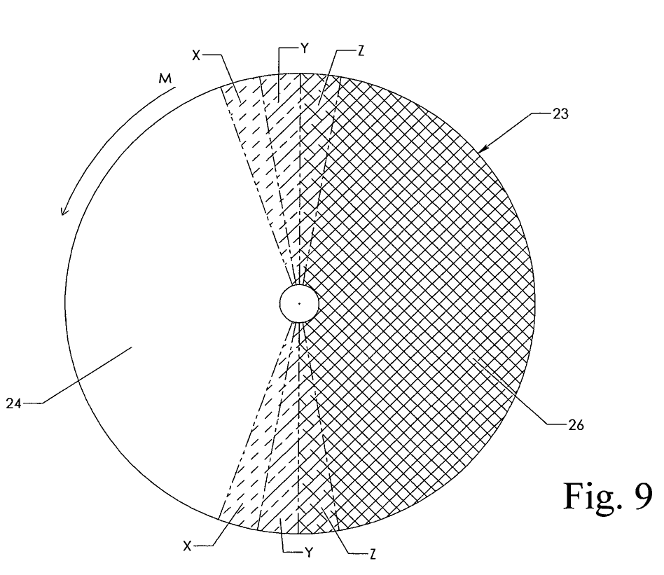

FIG. 9 is an example of an embodiment of the variable magnetic field conductor 23 with various regions representing portions of the variable magnetic field conductor 23 that are more magnetically conducting 26 and portions that are less magnetically conducting 24. What this figure shows is that, in the variable magnetic field conductor 23, there can be a gradual transition from the less magnetically conducting portions 24 to the more magnetically conducting portions 26, and vice versa. In the figure there is a gradual increase in the magnetically conducting properties of the material in regions X, Y, and Z, so that region Z is more magnetically conducting that region Y, and region Y is more magnetically conducting than region X. It should also be pointed out that the more magnetically conducting portion 26 is more magnetically conducting than region Z, and that the less magnetically conducting portion 24 is less magnetically conducting than region X. This figure is only one example of the various possible ways that a variable magnetic field conductor 23 could be constructed. The transition between regions with various magnetically conducting properties can be gradual or abrupt. Also, the materials that constitute any particular region can be of a single material, a composite of various materials, or a lamination of materials according to the requirements of the embodiment of a magnet engine. Though it is normally considered that laminations would be in the direction of the largest flat surface, as is the case with plywood, it is possible that in various embodiments of the variable magnetic field conductor 23 the laminations of various materials can be in any direction within the component.

It is also possible that the variable magnetic field conductor 23 be constructed from a diamagnetic material such as bismuth, a paramagnetic material such as aluminum, or materials with other magnetic properties, or a combination of these materials. The point is that the variable magnetic field conductor 23 be constructed of materials that alter the magnetic field that exists between the magnet 22 and piston 20 component pairs in such a way as to effect a reciprocating motion in the magnet 22 and piston 20 component pairs. This is to say that there is more than one way that the variable magnetic field conductor 23 can be constructed, and further, any manner of constructing the variable magnetic field conductor 23 is within the spirit and scope of the magnet engine that is disclosed herein.

FIG. 10 is an example of an embodiment of the variable magnetic field conductor 23 with various regions representing portions of the variable magnetic field conductor 23 that are more magnetically conducting 26 and portions that are less magnetically conducting 24. This example also depicts electrically conducting portions 99 of the variable magnetic field conductor 23. The electrically conducting portion 99 of the variable magnetic field conductor 23 would serve to reduce the attraction between the magnet 22 and piston 20 component pairs and the more magnetically conducting portion 26 of the variable magnetic field conductor 23 at the point of transition from more magnetically conducting portion 26 to less magnetically conducting portion 24. This would be effected by the eddy currents induced in the electrically conducting portion 99 of the variable magnetic field conductor 23 and the opposing magnetic field created in the electrically conducting portion 99 caused by its movement through the magnetic field between the magnet 22 and piston 20 component pairs. Much the same effect is used to levitate trains.

FIG. 10′ is an exploded view of the variable magnetic field conductor 23 depicted in FIG. 10. In this figure it can be clearly seen the means by which the electrically conducting portion 99 of less magnetically conducting portion 24 of the variable magnetic field conductor 23 overlays the more magnetically conducting portion 26 of the variable magnetic field conductor 23 and would serve to reduce the attraction between the magnet 22 and piston 20 component pairs and the more magnetically conducting portion 26 of the variable magnetic field conductor 23 at the point of transition from more magnetically conducting portion 26 to less magnetically conducting portion 24.

Variations of the embodiments discussed above can be made within the spirit and scope of the present invention. The foregoing discussion discloses and describes merely exemplary embodiments of the present invention. One skilled in the art will readily recognize from such discussion and from the accompanying drawings and claims that various changes, modifications, and variations can be made therein without departing from the spirit and scope of the invention as defined in the following claims.

What is claimed is:

1. A magnet engine comprising:
one or more in-line magnet and piston component pairs arranged circularly around and parallel to a central axis; that effect a reciprocating motion through the interaction of their magnetic fields with
one or more variable magnetic field conductors positioned generally between and generally equidistant from each magnet and piston component in a magnet and piston component pair; and
one or more cam drives positioned concentric to the central axis, around which the in-line magnet and piston component pairs are arranged; that translate the reciprocating motion of the magnet and piston components into rotary motion, in order to extract useful power output from the energy contained in a magnet.

2. The magnet engine of claim 1, further comprising:
a frame component for support, protection, and to maintain the position of the components of the magnet engine.

3. The magnet engine of claim 2, further comprising:
a flywheel component to sustain, maintain and smooth the motion of the magnet engine.

4. The magnet engine of claim 1, further comprising:
a variable magnetic field conductor comprised of more magnetically conducting portions and less magnetically conducting portions.

5. The magnet engine of claim 4, further comprising:
an electrically conducting portion of the variable magnetic field conductor that is integrated into the transition in the variable magnetic field conductor from more magnetically conducting portion to less magnetically conducting portion either by overlaying or as a surface or internal lamination.
